(19) United States
(12) Patent Application Publication
(10) Pub. No.: US 2007/0057756 A1
(43) Pub. Date: Mar. 15, 2007

(54) Structure of inductance core

(76) Inventor: Sen-Tai Yang, Taipei Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/224,482

(22) Filed: Sep. 12, 2005

(51) Int. Cl. H01F 27/24

(52) U.S. Cl. 336/212

(57) ABSTRACT

An improved structure of inductance core mainly includes a core made of high magnetic permeability (μ) and a wire frame. The core further includes a center post at the center section and two side posts at the end sections that are all salient in the same direction to a side of the core. A center hole, having a bobbin at the periphery thereof for the winding of a coil, is disposed at the center of the wire frame to let the center posts of two cores insert through respectively, together with the two side posts covering on the sides of the wire frame. By making use of the combination of the center posts, the wire frame can relatively extend such that the overlapped area of each layer of the coil can increase and the inductance leakage can be effectively lessen.

### BACKGROUND OF THE INVENTION

1. Field of the Invention

The invention relates to an improved structure of inductance core, and more particularly, to an inductance core that can effectively lessen the inductance leakage of the coil and maintain appropriate magnetic-induction efficiency.

2. Description of the Prior Art

As shown in FIG. 1, the core (5) of a conventional core structure of the inductance or the transformer appears mainly in E-shape. The core (5) includes a center post (51) and two side posts (53) that are salient in the same direction and disposed at the center and at the ends thereof respectively, as well as recessed portions (52) positioned between the center post (51) and the side posts (53). A wire frame (6), being accommodating the core (5) for assembling to become an inductance or a transformer, has a center hole (61) at the center thereof. The center hole (61) has a bobbin (62) at the periphery thereof for the winding of a coil (621). Welding post (63) having drawing heads (not shown in the Figure) for pulling out the wire (not shown in the Figure) from the coil (621) makes the center posts (51) of the two cores (5) insert into the center hole (61) of the wire frame (6). The center posts (51) then contact each other at their ends, and have their recessed portions (52) containing respectively the coils (621) at the periphery of the center hole (61). In the meantime, each of the side posts (53) of the two cores (5) forms a magnetic loop on the inner side of the coil (621) accommodated the center posts (51) at the two outer sides of the coil (621). However, since the covering area of the side posts (53) of the core (5) is rather small, a large portion of the coil (621) of these kinds of structure of the inductance or the transformer exposes to the air. This will result in serious inductance leakage of the coil and hardly improve the magnetic-induction efficiency.

Moreover, the structures as shown in FIG. 2 and FIG. 3 are the ones to facilitate the securing of the printed circuit board (PCB). The core (3) appearing mainly in E-shape, includes a center post (31) and two side posts (32) that are salient in the same direction and disposed at the center and at the ends thereof respectively. The center post (31) appears an offset between the two side posts (32) while each of the two side posts (32) has an extended portion (321) salient inward on the same side. What is more, a wire frame (4) accommodating the core (3) has a center hole (42) disposed at the center thereof. The center hole (42) has a bobbin at the periphery thereof for the winding of a coil (41). In addition, a lead-in seat (43) is equipped on each side of the wire frame (4) connecting to the vertically extended welding post (431) such that the center posts (31) of the cores (3) insert into the center hole (42) of the wire frame (4). In the meantime, the two side posts (32) of the cores (3) covers the periphery of the wire frame (4). Furthermore, the wire frame (4), by the use of the welding post (431), can insert and weld into the preset welding holes (not shown in the Figure). To reduce the exposed portion of the coil (41), one can makes use of the side extended portion (321) of the two side posts (32) to cover the two edges of the side surfaces that are on the opposite side of the lead-in seat (43) of the wire frame (4). Nevertheless, in order to avoid lowering the magnetic inductance efficiency resulting from the lengthy magnetic path, most of the above-mentioned conventional inductance or transformer have the design having the W (width) to L (length) ratio set to be around W:L=7:3. This design will results in relatively shorter in the available length of the bobbin of the coil (41) of their accommodating wire frames (4). As a result, they are apt to generate inductance leakage since the overlapped area of each layer of the coil (41) is relatively small. Therefore, just how to obtain a balance between improving the efficiency and lessening the inductance leakage has become an issue the relevant companies pursuit after.

### SUMMARY OF THE INVENTION

In light of the above-mentioned disadvantages of the prior art, the invention provides an improved structure of inductance core that can effectively lessen the inductance leakage of the coil and maintain appropriate magnetic-induction efficiency. It aims to ameliorate at least some of the disadvantages of the prior art or to provide a useful alternative.

The objective of the invention is to provide an improved structure of inductance core that includes two parts: a core and a wire frame. The core is made of material having high magnetic permeability (μ). The center section and the two end sections have a center post and two side posts respectively, and all these posts are salient toward the same direction such that the core's dimension ratio of its width W and its length L maintains 3:2.

At the center of the wire frame, there is a center hole having a bobbin at the periphery thereof for the winding of a coil. When it comes to assembling, two cores are matching face to face with their center posts inserting into the center hole of the wire frame to contact each other and have their two side posts covering the wire frame at its two sides. What is more, since the length of the wire frame increases in accordance with the center post of the core, the overlapped area of each layer of the coil increases accordingly. As a result, the inductance leakage can be effectively lessened.

The accomplishment of this and other objectives of the invention will become apparent from the following description and its accompanying drawings of which:

### BRIEF DESCRIPTION OF THE DRAWINGS

FIG. 1 is a schematic diagram of the inductance core and its relevant element structure of the prior art;

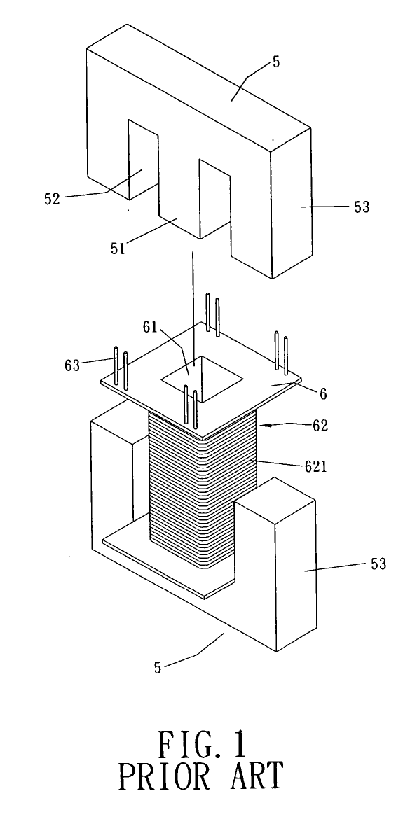

FIG. 2 is an exploded view of the inductance core and its relevant element structure of another prior art;

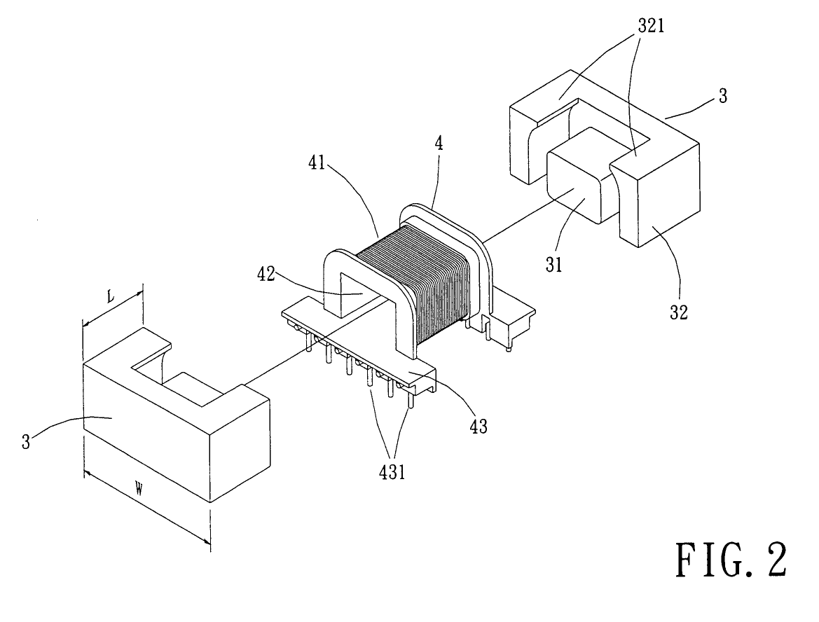

FIG. 3 is a schematic diagram of the inductance core and its relevant element structure of a further prior art;

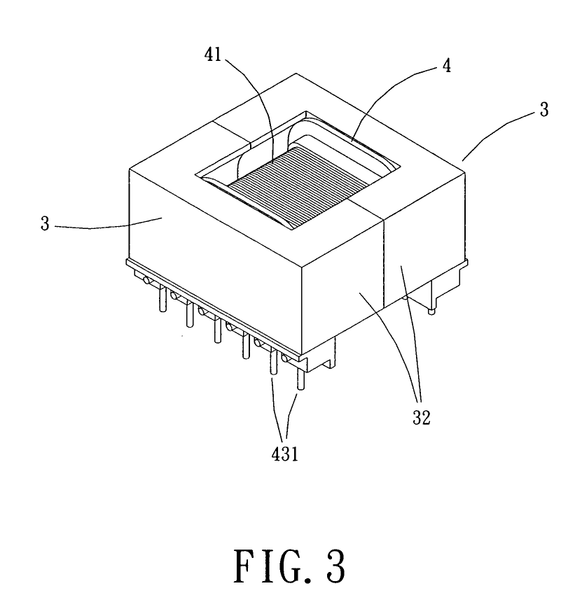

FIG. 4 is an exploded view of the inductance core and its relevant element structure of the invention;

FIG. 5 is an isometric view of the invention after being assembled.

### DETAILED DESCRIPTION OF THE PREFERRED EMBODIMENT

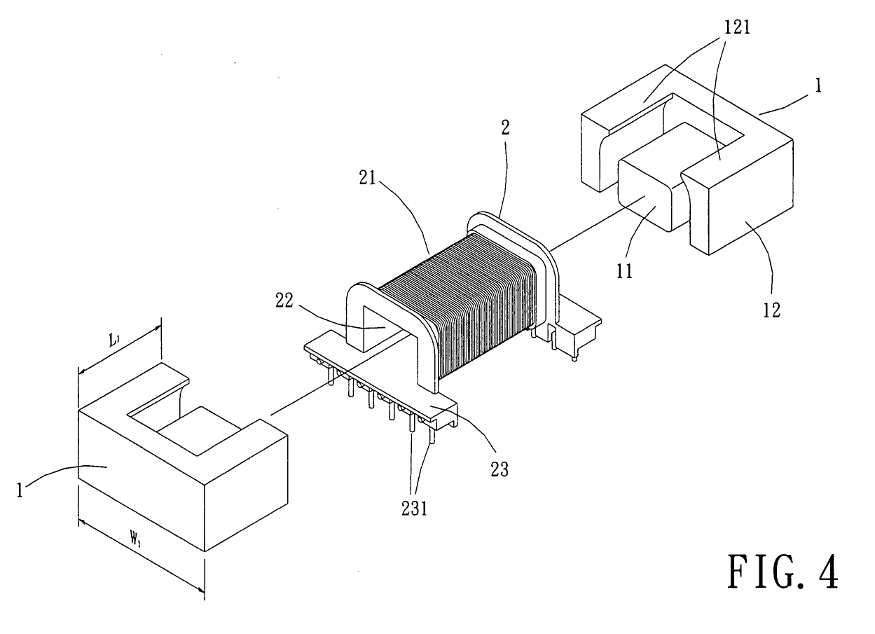

FIG. 4 is an exploded view of the inductance core and its relevant element structure of the invention. As shown in FIG. 4, the invention mainly includes two parts: a core (1) and a wire frame (2). The core (1) being appears in E-shape is made of material having high magnetic permeability (μ). The center section and the two end sections have a center post (11) and side posts (12) respectively, and all these posts are salient toward the same direction such that the core's (1) dimension ratio of its width W1 and its length L1 maintains 3:2 (with its length larger than that of the conventional core). Moreover, the center post (11) being offset in vertical direction (i.e. in a direction perpendicular to a plane of width-and-length, not shown in the Figure) becomes thinner in the same vertical direction between the side posts (12). Furthermore, the top end portions of the side posts have extended salient side portions (121) extending toward the center post (11). What is more, the length of the wire frame (2) is two times the length of the protruded center post (11). At the center of the wire frame (2), there is a center hole (22) having a bobbin at the periphery thereof for the winding of a coil (21). A lead-in seat (23) is equipped at each of the two ends of the wire frame (2) to connect respectively to the vertically extending welding post (231), thus to connect respectively to the drawing ends of the coil (21).

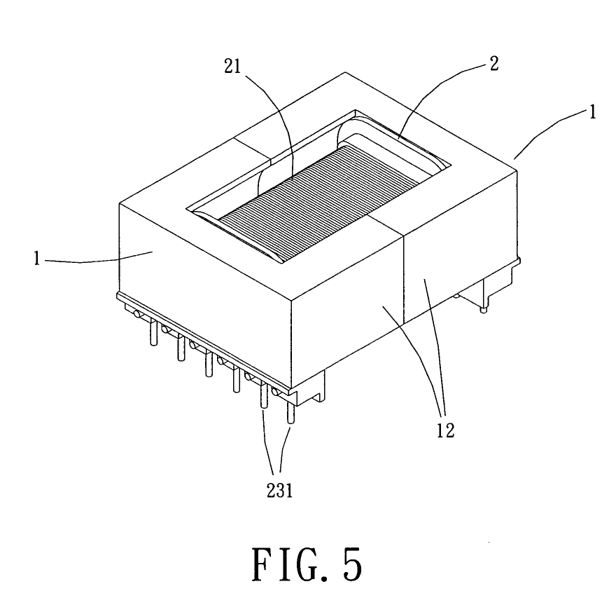

FIG. 5 is an isometric view of the invention after being assembled. As shown in FIG. 5, when it comes to assembling, two cores (1) are matching face to face with their center posts (11) inserting into the center hole (22) of the wire frame (2) to contact each other and have their two side posts (12) covering the wire frame (2) at its two sides. In the meantime, by the use of the welding post (231) to insert and weld to the welding holes on a preset PCB (printed circuit board), the wire frame (2) is attached thereon. Moreover, the exposed portion of the coil (21) can be reduced by making use of the extended salient side portions (121) to cover the two edges of the wire frame (2). What is more, since the length of the wire frame (2) increases in accordance with the center post (11) of the core (1), the overlapped area of each layer of the coil (21) increases accordingly. As a result, the inductance leakage can be effectively lessen.

In the above-mentioned structure, since the length proportion of the two cores (1) increase, the situation that the increase of the magnetic path resulted from their matching combination causes the lowering of the conductance efficiency can be overcome by increasing the magnetic permeability (μ) of the material of the core (1).

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. An improved structure of inductance core comprising a core and a wire frame wherein the center section and the two end sections of the core have a center post and side posts respectively, and all these posts are salient toward the same direction, and at the center of the wire frame, there is a center hole having a bobbin at the periphery thereof for the winding of a coil such that the core and the wire frame can become a combination which is characterized in that the core's dimension ratio of its width W1 and its length L1 maintains 3:2 such that the overlapped area of each layer of the coil can be increased and the inductance leakage can be effectively lessen.

2. The improved structure of inductance core as claimed in claim 1, wherein the core is made of a material of high magnetic permeability (μ), and by making use of that the lowering of the conductance efficiency, which is resulted from the increase of the magnetic path due to the increase of the core length the conductance efficiency, can be lessened.
